(19) United States
(12) Patent Application Publication
(10) Pub. No.: US 2007/0179053 A1
(43) Pub. Date: Aug. 2, 2007

(54) Composite oxide support, catalyst for low temperature water gas shift reaction and methods of preparing the same

(75) Inventors: Hyun-chul Lee, Yongin-si (KR); Soon-ho Kim, Yongin-si (KR); Doo-hwan Lee, Yongin-si (KR); Yulia Potapova, Yongin-si (KR); Ok-young Lim, Yongin-si (KR); Eun-duck Park, Yongin-si (KR); Eun-yong Ko, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/634,108

(22) Filed: Dec. 6, 2006

(30) Foreign Application Priority Data
Feb. 2, 2006 (KR) 2006-10054

(51) Int. Cl. B01J 23/00; B01J 8/02; H01M 8/06

(52) U.S. Cl. 502/304; 422/211; 429/19

(57) ABSTRACT

A composite oxide support containing ceria and an oxide of M₁(M₁ being Al, Zr or Ti) such that the atomic ratio of cerium to M₁ is in the range of 1:4 to 1:40; a method of preparing the composite oxide support; a catalyst for low temperature water gas shift reaction, having a transition metal active component supported on the composite oxide support by an incipient wetness method; and a method of preparing the catalyst for low temperature water gas shift reaction are provided. The catalyst for low temperature water gas shift reaction prepared by using the composite oxide support can effectively remove carbon monoxide from the hydrogen produced from the low temperature water gas shift reaction at a lower temperature with a higher carbon monoxide conversion rate, compared with conventional catalysts for water gas shift reaction.

### CROSS-REFERENCE TO RELATED PATENT APPLICATIONS

This application claims the benefit of Korean Application No. 2006-10054, filed Feb. 2, 2006, in the Korean Intellectual Property Office, the disclosure of which is incorporated herein in its entirety by reference.

### BACKGROUND OF THE INVENTION

1. Field of the Invention

Aspects of the present invention relate to a composite oxide support, a method of preparing the composite oxide support, a low temperature water gas shift reaction catalyst employing the composite oxide support, and a method of preparing the low temperature water gas shift reaction catalyst. In particular, aspects of the present invention relate to a composite oxide support exhibiting a higher carbon monoxide conversion at a lower temperature, a method of preparing the composite oxide support, a low temperature water gas shift reaction catalyst employing the composite oxide support, and a method of preparing the low temperature water gas shift reaction catalyst.

2. Description of the Related Art

A fuel cell is a type of power-generating system that directly converts the chemical energy of oxygen and hydrogen contained in hydrocarbonaceous materials such as methanol, ethanol and natural gas into electrical energy.

A fuel cell typically includes a fuel cell stack, a fuel processor (FP), a fuel tank, and a fuel pump. The fuel cell stack constitutes the main body of the fuel cell, and has a structure in which a few to a few tens of unit cells are stacked, with each unit cell consisting of a membrane-electrode assembly (MEA) and a separator (or bipolar plate). The fuel pump supplies fuel from the fuel tank to the fuel processor, and the fuel processor reforms and purifies the fuel to generate hydrogen, which is fed to the fuel cell stack. The hydrogen entering the fuel cell stack reacts electrochemically with oxygen to generate electrical energy.

FIG. 1 is a block diagram that shows stages of fuel processing in a fuel processor of a fuel cell system. Since hydrocarbons contain sulfur compounds, and since catalysts in the fuel processor are susceptible to poisoning by sulfur compounds, it is first necessary to remove the sulfur compounds from the hydrocarbons before supplying the hydrocarbons to the later stages of the fuel processor. Thus, a fuel processor includes a desulfurizer as shown in FIG. 1. A reformer in the fuel processor reforms desulfurized hydrocarbons using a reforming catalyst.

Although the process of reforming hydrocarbons predominantly generates hydrogen, the same process also generates carbon dioxide and a small amount of carbon monoxide as well. Since carbon monoxide can poison catalysts used in the electrodes of the fuel cell stack, the carbon monoxide should be removed from the reformed fuel before the reformed fuel is fed to the fuel cell stack. For example, the amount of carbon monoxide contained in the reformed fuel may be reduced to 10 ppm or less after a process for carbon monoxide removal.

A high temperature water gas shift reaction as shown in Reaction Scheme 1 below is used to remove carbon monoxide:

CO+H₂O→CO₂+H₂ [Reaction Scheme 1]

Typically, this high temperature water gas shift reaction is effectively achieved only at a high temperature in the range of 400° C. to 500° C., and thus, the high temperature water gas shift reaction requires many additional apparatuses, and is disadvantageous in terms of energy utilization. Moreover, a methanation reaction may occur as shown in Reaction Scheme 2 below, in which the carbon monoxide to be removed reacts in turn with hydrogen to produce a hydrocarbon, thus making the high temperature water gas shift reaction highly unfavorable:

CO+3H₂→CH₄+H₂O [Reaction Scheme 2]

In addition to the high temperature water gas shift reaction, a low temperature water gas shift reaction, which is effectively achieved at a temperature in the range of 200° C. to 300° C., may be used. However, even through these reactions, it is difficult for the amount of CO contained in the reformed fuel to be reduced to 5,000 ppm or less.

In an effort to address such disadvantages, a so-called PROX (Preferential Oxidation) reaction as shown in Reaction Scheme 3 below may be used:

CO+½O₂→CO₂ [Reaction Scheme 3]

However, the conventional water gas shift reactions mentioned above require two reaction steps, thus demanding sophisticated apparatuses, and the catalysts used therein have low heat resistance and impose limits on the temperature, which needs to be increased to enhance the reactivity. Furthermore, the conventional water gas shift reactions have to be performed slowly in view of catalyst activation and stability, and thus, the processes for catalyst reduction and activation may require prolonged processing times. In addition, since the catalysts used for the conventional water gas shift reactions are pyrophoric, the apparatuses containing the catalysts need to be filled with an inert gas such as nitrogen upon shutdown of the apparatuses in order to protect the catalysts, thus causing inconvenience.

Therefore, there has been a strong demand for a catalyst that can solve such problems, and that also has high activity even at low temperatures. However, there has been no single catalyst satisfying both of these conditions.

### SUMMARY OF THE INVENTION

Aspects of the present invention provide a composite oxide support having a high specific surface area, which, when used as a support for a low temperature water gas shift reaction catalyst, allows the low temperature water gas shift reaction catalyst to have high carbon monoxide removal performance.

Aspects of the present invention also provide a method of producing the composite oxide support.

Aspects of the present invention also provide a low temperature water gas shift reaction catalyst that has a high degree of dispersion and has high carbon monoxide removal performance even at low temperatures.

Aspects of the present invention also provide a method of producing the low temperature water gas shift reaction catalyst.

Aspects of the present invention also provide a method of removing carbon monoxide from a gas containing carbon monoxide using the low temperature water gas shift reaction catalyst.

Aspects of the present invention also provide a fuel processor having a high carbon monoxide removal performance even at low temperatures.

Aspects of the present invention also provide a fuel cell system that has an enhanced cell efficiency and that can efficiently remove carbon monoxide from a gas containing carbon monoxide at low temperatures.

According to an aspect of the present invention, there is provided a composite oxide support comprising ceria (CeO₂) and an oxide of M₁ such that the atomic ratio of cerium in the ceria to M₁ is in the range of 1:4 to 1:40, wherein M₁ is at least one metal selected from aluminum (Al), zirconium (Zr) and titanium (Ti).

According to another aspect of the present invention, there is provided a method of producing a composite oxide support, comprising dissolving a ceria (CeO₂) precursor in a mixed solvent of an alcohol-based solvent and an acid to obtain a first oxide precursor solution; dissolving at least one metal oxide precursor selected from alumina (Al₂O₃) precursors, zirconia (ZrO₂) precursors and titania (TiO₂) precursors in a mixed solvent of an alcohol-based solvent and an acid to obtain a second oxide precursor solution; mixing and heating the first oxide precursor solution and the second oxide precursor solution to form a solution mixture in a gel state; and calcining the solution mixture in the gel state.

According to another aspect of the present invention, there is provided a low temperature water gas shift reaction catalyst, comprising: a composite oxide support that comprises ceria (CeO₂) and an oxide of M₁ such that the atomic ratio of cerium in the ceria to M₁ is in the range of 1:4 to 1:40 and wherein M₁ includes at least one metal selected from aluminum (Al), zirconium (Zr) and titanium (Ti); and a transition metal active component supported on the composite oxide support.

According to another aspect of the present invention, there is provided a method of producing a catalyst for low temperature water gas shift reaction, comprising dissolving a ceria (CeO₂) precursor in a mixed solvent of an alcohol-based solvent and an acid to obtain a first oxide precursor solution; dissolving at least one metal oxide precursor selected from alumina (Al₂O₃) precursors, zirconia (ZrO₂) precursors and titania (TiO₂) precursors in a mixed solvent of an alcohol-based solvent and an acid to obtain a second oxide precursor solution; mixing and heating the first oxide precursor solution and the second oxide precursor solution to form a solution mixture in a gel state; calcining the solution mixture in the gel state to produce a composite oxide support; impregnating a transition metal active component into the composite oxide support by using an incipient wetness method; and calcining the impregnation product.

According to another aspect of the present invention, there is provided a method of removing carbon monoxide from a gas containing carbon monoxide using the catalyst for temperature water gas shift reaction, comprising contacting the catalyst for low temperature water gas shift reaction, with the gas containing carbon monoxide.

According to another aspect of the present invention, there is provided a fuel processor containing the composite oxide support.

According to another aspect of the present invention, there is provided a fuel cell system containing the composite oxide support.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram for illustrating stages of fuel processing in a fuel processor used in fuel cell systems;

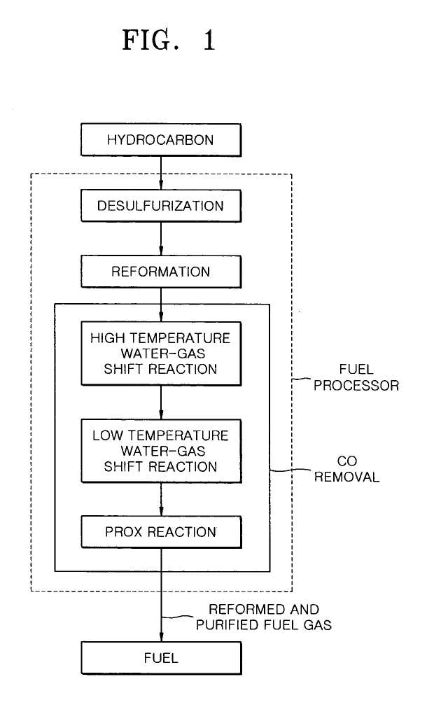

FIG. 2 is a block diagram for illustrating a method of preparing a composite oxide support according to an embodiment of the present invention;

FIG. 3 is a block diagram for illustrating a method of preparing a low temperature water gas shift reaction catalyst according to an embodiment of the present invention; and

FIG. 4A and FIG. 4B are graphs showing the test results for the carbon monoxide removal performance of the supported catalysts prepared in Examples 1 and 2 and Comparative Example 3 of embodiments of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An embodiment of the present invention provides a composite oxide support comprising ceria (CeO₂) and an oxide of M₁ such that the atomic ratio of cerium (Ce) in the ceria to M₁ is in a range of 1:4 to 1:40, wherein M₁ is at least one metal selected from aluminum (Al), zirconium (Zr) and titanium (Ti).

When cerium is present in excess so that the atomic ratio of cerium to M₁ is larger than 1:4, the catalyst to be produced using the composite oxide support may not be fully activated. On the other hand, when too little cerium is present so that the atomic ratio of cerium to M₁ is smaller than 1:40, the increase in the activity of the catalyst on the composite oxide support induced by the presence of cerium becomes negligible, and the effect of the activity enhancement may be reduced.

In the composite oxide support according to the current embodiment, the oxide of M₁ constitutes the main skeleton of the composite oxide support, and ceria is distributed within the main skeleton formed by the oxide of M₁. The ceria and the oxide of M₁ form a crystalline structure in the composite oxide support, in which structure the two components are microscopically mixed. The type of the crystalline phase is not particularly limited.

The oxide of M₁ may include alumina (Al₂O₃), zirconia (ZrO₂) and/or titania (TiO₂), for example, but is not limited thereto. As a specific non-limiting example, the oxide of M₁ may be alumina.

The composite oxide support according to a specific, non-limiting embodiment of the present invention may contain ceria in an amount of 3 to 20% by weight, based on the total weight of the composite oxide support. In this embodiment, if the amount of ceria is less than 3% by weight, the effect of the activity enhancement due to the presence of ceria may be reduced. On the other hand, if the amount of ceria is larger than 20% by weight, the catalyst to be produced using the composite oxide support may not be activated.

The specific surface area of the composite oxide support may be in a range of 20 m²/g to 1,500 m²/g. If the specific surface area of the composite oxide support is smaller than 20 m²/g, the activity of the low temperature water gas shift reaction catalyst to be produced using the composite oxide support may be insufficient. If the specific surface area of the composite oxide support is larger than 1,500 m²/g, the mechanical properties of the composite oxide support may be unsatisfactory.

Another embodiment of the present invention provides a method of producing the composite oxide support comprising dissolving a ceria (CeO₂) precursor in a mixed solvent of an alcohol-based solvent and an acid; dissolving at least one metal oxide precursor selected from alumina (Al₂O₃) precursors, zirconia (ZrO₂) precursors and titania (TiO₂) precursors in a mixed solvent of an alcohol-based solvent and an acid; mixing and heating the resulting solutions to form a solution mixture in a gel state; and calcining the solution mixture in the gel state.

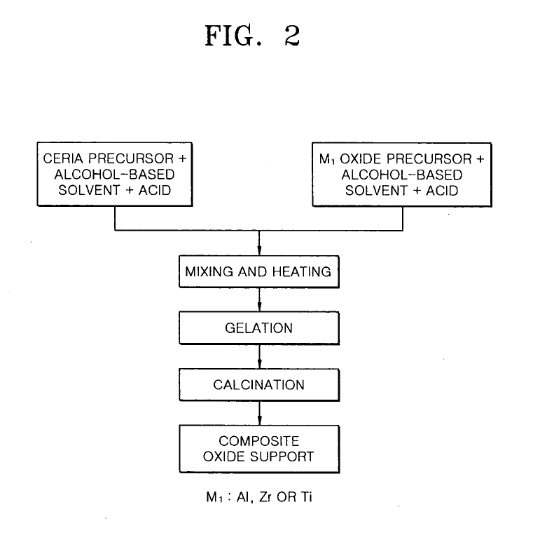

FIG. 2 is a block diagram that illustrates the method of producing a composite oxide support according to this embodiment.

The ceria precursor may include at least one selected from the group consisting of Ce(NO₃)₃.H₂O, Ce(CH₃CO₂)₃, Ce(CO₃)₃, CeCl₃, (NH₄)₂Ce(NO₃)₆, (NH₄)₂Ce(SO₄)₄, Ce(OH)₄, Ce₂(C₂O₄)₃, Ce(ClO₄)₃ and Ce₂(SO₄)₃, but is not limited thereto. The alumina precursor may include at least one selected from the group consisting of Al(NO₃)₃.9H₂O, AlCl₃, Al(OH)₃, AlNH₄(SO₄)₂.12H₂O, Al((CH₃)₂CHO)₃, Al(CH₃CH(OH)CO₂, Al(ClO₄)₃.9H₂O, Al(C₆H₅O)₃, Al₂(SO₄)₃.18H₂O, Al(CH₃(CH₂)₃O)₃, Al(C₂H₅CH(CH₃)O)₃Al and Al(C₂H₅O)₃, but is not limited thereto. The zirconia precursor may include at least one selected from the group consisting of ZrO(NO₃)₂, ZrCl₄, Zr(OC(CH₃)₃)₄, Zr(O(CH₂)₃CH₃)₄, (CH₃CO₂)Zr(OH), ZrOCl₂,Zr(SO₄)₂, and Zr(OCH₂CH₂CH₃)₄, but is not limited thereto. The titania precursor may include at least one selected from the group consisting of Ti(NO₃)₄, TiOSO₄, Ti(OCH₂CH₂CH₃)₄, Ti(OCH(CH₃)₂)₄, Ti(OC₂H₅)₄, Ti(OCH₃)₄, TiCl₃, Ti(O(CH₂)₃CH₃)₄ and Ti(OC(CH₃)₃)₄, but is not limited thereto.

In the solution prepared by dissolving a ceria precursor in a mixed solvent of an alcohol-based solvent and an acid, the weight ratio of the ceria precursor, the alcohol-based solvent and the acid may be in a range of 1:10:2 to 1:80:20. When the proportion of the acid is larger than the upper limit of the range, calcination of the solution mixture of the oxide precursor solutions, which is to be formed in a subsequent process, may take a long time. When the proportion of the acid is smaller than the lower limit of the range, mixing of the oxide precursors may not be satisfactorily achieved. When the proportion of the alcohol-based solvent is larger than the upper limit of the range, calcination of the solution mixture of the oxide precursor solutions, which is to be formed in the subsequent process, may take a long time. When the proportion of the alcohol-based solvent is smaller than the lower limit of the range, mixing of the oxide precursors may not be satisfactorily achieved.

The solution prepared by dissolving at least one metal oxide precursor selected from alumina precursors, zirconia precursors and titania precursors in a mixed solvent of an alcohol-based solvent and an acid, may contain the at least one metal oxide precursor selected from alumina precursors, zirconia precursors and titania precursors; the alcohol-based solvent; and the acid in a weight ratio in a range of 1:10:2 to 1:80:20. When the proportion of the acid is larger than the upper limit of the range, calcination of the solution mixture of the oxide precursor solutions, which is to be formed in the subsequent process, may take a long time. When the proportion of the acid is smaller than the lower limit of the range, mixing of the oxide precursors may not be satisfactorily achieved. On the other hand, when the proportion of the alcohol-based solvent is larger than the upper limit of the range, calcination of the solution mixture of the oxide precursor solutions, which is to be formed in the subsequent process, may take a long time. When the proportion of the alcohol-based solvent is smaller than the lower limit of the range, mixing of the oxide precursors may not be satisfactorily achieved.

When preparing the two solutions, the atomic ratio of cerium in the ceria precursor to the metal component in the at least one metal oxide precursor selected from alumina precursors, zirconia precursors and titania precursors, may be adjusted to 1:4 to 1:40. If cerium is present in excess so that the atomic ratio of cerium to the metal component selected from aluminum, zirconium and titanium is larger than 1:4, the catalyst to be produced may not be fully activated. On the other hand, when too little cerium is present so that the atomic ratio of cerium to the metal component selected from aluminum, zirconium and titanium is smaller than 1:40, the effect of the activity enhancement due to the presence of ceria may be reduced.

The acid used for the mixed solvent of an alcohol-based solvent and an acid may be exemplified by an inorganic acid such as hydrochloric acid, sulfuric acid, nitric acid, phosphoric acid or boric acid, or an organic acid such as an aliphatic carboxylic acid having 1 to 20 carbon atoms or an aromatic carboxylic acid having 6 to 30 carbon atoms, but is not limited thereto.

Examples of the aliphatic carboxylic acid include formic acid, acetic acid, propionic acid, citric acid, tartaric acid, fulvic acid, tannic acid, malic acid, fumaric acid, maleic acid, aspartic acid, oxalic acid, malonic acid, succinic acid, glutaric acid, adipic acid, pimelic acid and the like, but are not limited to these.

Examples of the aromatic carboxylic acid include benzoic acid, salicylic acid, phthalic acid, isophthalic acid, terephthalic acid, benzenesulfonic acid and the like, but are not limited to these.

The alcohol-based solvent used for the mixed solvent of an alcohol-based solvent and an acid may be exemplified by a monohydric alcohol having 1 to 10 carbon atoms, or a dihydric alcohol having 1 to 10 carbon atoms, but is not limited thereto.

Examples of the monohydric alcohol include methanol, ethanol, propanol, butanol, pentanol, hexanol, phenol which is unsubstituted or substituted with an alkyl group having 1 to 4 carbon atoms, and the like, but are not limited to these.

Examples of the dihydric alcohol include methanediol, ethanediol, propanediol, butanediol, pentanediol, hexanediol, catecol which is unsubstituted or substituted with an alkyl group having 1 to 4 carbon atoms, resorcinol which is unsubstituted or substituted with an alkyl group having 1 to 4 carbon atoms, hydroquinone which is unsubstituted or substituted with an alkyl group having 1 to 4 carbon atoms, and the like, but are not limited to these.

After preparing the two oxide precursor solutions, the two oxide precursor solutions are mixed while heating. The temperature to be reached by the oxide precursor solutions during the process of mixing and heating may be in the range of 100° C. to 200° C. If the temperature of the oxide precursor solutions is lower than 100° C., the ceria precursor, alumina precursor, zirconia precursor or titania precursor may not dissolve rapidly. If the temperature of the oxide precursor solutions is higher than 200° C., the alcohol-based solvent and the acid may evaporate too rapidly, and the two oxide precursor solutions may not be sufficiently mixed.

The duration of the process of mixing the two oxide precursor solutions is not particularly limited, and may be arbitrarily selected from a range of durations in which the resulting solution mixture becomes homogeneous and finally achieves the gel state. The duration may be, for example, 30 minutes to 10 hours.

The solution mixture thus prepared may then be, calcined, for example by heating the solution mixture in a sealed heating chamber such as an oven, in order to remove the alcohol-based solvent and the acid, and to enhance the crystallinity of the support being produced. The calcination process may be performed, for example, in air, but the present invention is not limited thereto.

Typically, the calcination process may be performed at a temperature of 400° C. to 700° C. If the calcination process is performed at a temperature lower than 400° C., the resulting composite oxide support may not have sufficient crystallinity. If the calcination process is performed at temperature higher than 700° C., the resulting composite oxide support has excellent crystallinity but may have a reduced specific surface area.

The calcination process may be performed for 2 hours to 24 hours. Generally, if the duration of the calcination process is shorter than 2 hours, the time is not sufficient to remove all of the acid and organic solvent used. Generally, if the duration of the calcination process is longer than 24 hours, time is unnecessarily wasted, which is economically unfavorable.

When the calcination process is completed, a composite oxide support according to an aspect of the present invention is obtained.

According to another embodiment of the present invention, there is provided a low temperature water gas shift reaction catalyst, comprising: a composite oxide support that comprises ceria (CeO₂) and an oxide of M₁ such that the atomic ratio of cerium in the ceria to M₁ is in the range of 1:4 to 1:40, wherein M₁ includes at least one metal selected from aluminum (Al), zirconium (Zr) and titanium (Ti); and a transition metal active component supported on the composite oxide support. As used herein, the term “low temperature water gas shift reaction catalyst” is used would be commonly understood in the art to refer to a catalyst that catalyses a water gas shift reaction, such as, for example, the water gas shift reaction shown in Reaction Scheme 1, above, at a relatively low temperature, such as, for example, a temperature in the range of 200° C. to 300° C.

The low temperature water gas shift reaction catalyst according to the current embodiment may have a transition metal active component supported on the composite oxide support. The transition metal active component can be any transition metal that promotes a reaction of converting carbon monoxide and water to carbon dioxide and hydrogen, and is not particularly limited. Specific examples of the transition metal active component include platinum (Pt), and alloys of platinum with palladium (Pd), nickel (Ni), cobalt (Co), ruthenium (Ru), rhenium (Re), rhodium (Rh), osmium (Os), titanium (Ti), vanadium (V), chromium (Cr), manganese (Mn), iron (Fe), copper (Cu), cerium(Ce) and zinc (Zn), but are not limited to these.

The proportion of the transition metal active component may be, for example, 1 to 10% by weight, based on the total weight of the low temperature water gas shift reaction catalyst. When the proportion of the transition metal active component is less than 1% by weight of the low temperature water gas shift reaction catalyst, the catalyst activity may be insufficient. On the other hand, when the proportion of the transition metal active component is larger than 10% by weight of the low temperature water gas shift reaction catalyst, the process may be economically unfavorable.

The degree of dispersion of particles of the transition metal active component may be 60% or greater. For example, the degree of dispersion may be a value approaching 100%. The degree of dispersion of particles of the transition metal active component is defined as the atomic ratio of the transition metal active component exposed on the surface of the composite oxide support, to the total transition metal active component supported on the composite oxide support, expressed as a percentage. If the degree of dispersion of particles of the transition metal active component is lower than 60%, the degree of utilization of expensive transition metals may be lowered, and the process may be economically disadvantageous because of lowered catalyst activity.

Another embodiment of the present invention provides a method of producing a low temperature water gas shift reaction catalyst, comprising dissolving a ceria (CeO₂) precursor in a mixed solvent of an alcohol-based solvent and an acid; dissolving at least one metal oxide precursor selected from alumina (Al₂O₃) precursors, zirconia (ZrO₂) precursors and titania (TiO₂) precursors in a mixed solvent of an alcohol-based solvent and an acid; mixing and heating the resulting solutions to form a solution mixture in a gel state; calcining the solution mixture in the gel state to produce a composite oxide support; impregnating a transition metal active component into the composite oxide support by an incipient wetness method; and calcining the impregnated product.

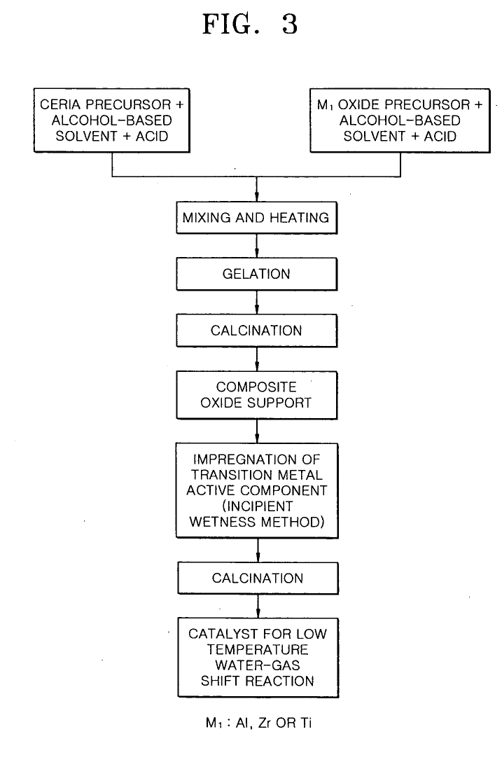

FIG. 3 is a block diagram for illustrating a method of producing a low temperature water gas shift reaction catalyst according to an embodiment of the present invention.

The method of producing a low temperature water gas shift reaction catalyst according to an embodiment of the present invention comprises a part or the entirety of the method of producing a composite oxide support of the present invention described above. Therefore, in the description of the method of producing a low temperature water gas shift reaction catalyst of the present invention to follow, the portion of the subject matter that is overlapping with the description of the method of producing a composite oxide support will be omitted.

The process of impregnating the transition metal active component into the composite oxide support is performed according to an incipient impregnation method.

That is, while taking into account the amount of the composite oxide support to be used in the production of a supported catalyst, a material containing the transition metal active component is dissolved in a solvent. For example, the material containing the transition metal active component may be a transition metal active component precursor. The solvent is not particularly limited, and can be any solvent that can dissolve the material containing the transition metal active component. The solvent may be, for example, water or an alcohol-based solvent. Generally, the amount of the solvent should not exceed an amount that can be entirely absorbed by the composite oxide support. In particular, the amount of the solvent may be the maximum amount that the composite oxide support can absorb.

The solution prepared by dissolving the material containing the transition metal active component in the solvent is then added dropwise to the composite oxide support. When all of the solution is added dropwise to the composite oxide support, the surface of the composite oxide support having absorbed the solution becomes wet.

This mixture formed from the solution of the material containing the transition metal active component and the composite oxide support is then dried to remove the solvent. The method of drying is not particularly limited. For example, the drying can be performed in an oven for 5 hours to 24 hours.

The mixture prepared as above is subjected to calcination by heating the mixture in a sealed heating chamber such as an oven. The calcination process can be performed, for example, in air, but is not limited thereto.

Typically, the calcination process may be performed at a temperature of 300° C. to 700° C. If the calcination process is performed at a temperature lower than 300° C., a component other than the transition metal active component may not be sufficiently eliminated. If the calcination process is performed at a temperature higher than 700° C., the particles of the transition metal active component may grow too large in size and the catalyst activity may be reduced. For example, if a platinum precursor is used as the transition metal active component and the calcination process is performed at a temperature lower than 300° C., the component other than platinum in the platinum precursor may not be sufficiently eliminated. If the calcination process is performed at a temperature higher than 700° C., the platinum particles may grow too large in size and the catalyst activity may be reduced.

Typically, the calcination process may be performed for 1 hour to 24 hours. If the duration of the calcination process is shorter than 1 hour, crystals may not be formed sufficiently. If the duration of the calcination process is longer than 24 hours, time is unnecessarily wasted, which is economically unfavorable.

According to another embodiment of the present invention, a method of removing carbon monoxide from a gas containing carbon monoxide using the low temperature water gas shift reaction catalyst according to aspects of the present invention is provided. That is, carbon monoxide can be removed from a gas containing carbon monoxide by contacting the low temperature water gas shift reaction catalyst produced as described above, with the gas containing carbon monoxide.

The process of contacting the low temperature water gas shift reaction catalyst with a gas containing carbon monoxide may be performed at a temperature of 200° C. to 280° C. When the temperature is lower than 200° C., the low temperature may impede the reaction. When the temperature is higher than 280° C., the reaction equilibrium may be shifted toward the reactants, rather than toward the products, and a desired carbon monoxide conversion rate may not be achieved.

According to another embodiment of the present invention, a fuel processor containing the composite oxide support according to aspects of the present invention is provided. Hereinafter, the fuel processor containing the composite oxide support according to aspects of the present invention will be described.

The fuel processor may comprise a desulfurizer, a reformer, an apparatus for a low temperature water gas shift reaction, an apparatus for a high temperature water gas shift reaction, and an apparatus for a PROX reaction. The apparatuses for the low temperature water gas shift reaction, the high temperature water gas shift reaction reactors, the PROX reaction may also be referred to as reactors.

The desulfurizer is an apparatus that removes sulfur compounds from hydrocarbons that are supplied as fuel, so that the sulfur compounds do not poison the catalysts contained in the subsequent apparatuses. The desulfurization process may be performed by using adsorbents that are well known in the related art, or by using a hydrodesulfurization (HDS) method.

The reformer is an apparatus that reforms the hydrocarbons that are supplied as fuel. The catalyst used for this reformer may be a catalyst well known in the related art, such as, for example, platinum, ruthenium or rhenium.

The apparatus for the high temperature water gas shift reaction and the apparatus for the low temperature water gas shift reaction are apparatuses that remove carbon monoxide from the hydrogen produced by reformation, since carbon monoxide poisons the catalyst layer of a fuel cell. The apparatus for the high temperature water gas shift reaction and the apparatus for the low temperature water gas shift reaction together may reduce the concentration of carbon monoxide to less than 1%. The low temperature water gas shift reaction catalyst according to aspects of the present invention may be contained in the apparatus for the low temperature water gas shift reaction. The low temperature water gas shift reaction catalyst according to aspects of the present invention can be charged in the apparatus for low temperature water gas shift reaction, for example, as a fixed bed.

According to an embodiment of the present invention, the apparatus for the high temperature water gas shift reaction and the apparatus for the low temperature water gas shift reaction may be combined into a single apparatus for carrying out the water gas shift reaction, instead of being provided separately, and the single apparatus may be packed with the low temperature water gas shift reaction catalyst according to aspects of the present invention, to achieve the same effect. Since the low temperature water gas shift reaction catalyst according to aspects of the present invention has excellent performance for carbon monoxide removal, the case where a single apparatus for water gas shift reaction is employed produces results as good as the case where separate apparatuses for low temperature water gas shift reaction and high temperature water gas shift reaction are employed.

The apparatus for the PROX reaction is an apparatus that further reduces the concentration of carbon monoxide to less than 10 ppm. The apparatus is typically packed with a catalyst known in the related art.

Another embodiment of the present invention provides a fuel cell system containing the composite oxide support according to aspects of the present invention.

The fuel cell system according to an embodiment of the present invention mainly comprises a fuel processor and a fuel cell stack. The fuel processor may comprise, as described above, a desulfurizer, a reformer, an apparatus for the high temperature water gas shift reaction, an apparatus for the low temperature water gas shift reaction, and an apparatus for the PROX reaction. The fuel cell stack may comprise a plurality of unit fuel cells that are stacked or arranged in an array. Each of the unit fuel cells comprises a cathode, an anode and an electrolyte membrane interposed between the cathode and the anode, and may further comprise separators.

The composite oxide support according to aspects of the present invention can be used in the production of a low temperature water gas shift reaction catalyst, since it has a transition metal active component supported thereon. The composite oxide support can be contained in the fuel processor, and more specifically, in one of the apparatuses for the water gas shift reaction, in particular, the apparatus for the low temperature water gas shift reaction.

Hereinafter, the constitution and effect of aspects of the present invention will be described in detail with reference to Examples and Comparative Examples. However, these Examples and Comparative Examples are for illustrative purposes only, and are not intended to limit the present invention.

### EXAMPLE 1

Production of Composite Oxide Support

7.1 g of Ce(NO₃)₃.6H₂O was dissolved in a mixed solvent containing 40.7 g of ethylene glycol and 34.4 g of citric acid to produce a solution (E1A solution). Meanwhile, 24.6 g of Al(NO₃)₃.9H₂O was dissolved in a mixed solvent containing 162.8 g of ethylene glycol and 137.8 g of citric acid to produce another solution (E1B solution).

The E1A solution and the E1B solution were each stirred while heating to 100° C., so that each solution became homogeneous. Then, the E1A solution and E1B solution were mixed together and stirred for 7 hours, while heating to 200° C., until the solution mixture turned into a gel.

The gel thus formed was placed in an oven and was calcined in air at 500° C. for 4 hours, to obtain a composite oxide support. The atomic ratio of cerium to aluminum in the composite oxide support was 2:8.

Production of Supported Catalyst

0.405 g of Pt(NH₃)₄(NO₃)₂, which is a platinum precursor, was dissolved in 5 ml of water, and then the resulting solution was added dropwise to 10 g of the composite oxide support produced above. After the dropwise addition was completed, the composite oxide support having absorbed the solution of platinum precursor was dried in an oven at 110° C. for 16 hours, and then was calcined in air in an oven at 500° C. for 4 hours. Thus, a supported catalyst was obtained.

### EXAMPLE 2

Production of Composite Oxide Support

4.0 g of Ce(NO₃)₃.6H₂O was dissolved in a mixed solvent containing 23.0 g of ethylene glycol and 19.5 g of citric acid to produce a solution (E2A solution). Meanwhile, 31.3 g of Al(NO₃)₃.9H₂O was dissolved in a mixed solvent containing 207.2 g of ethylene glycol and 175.38 g of citric acid to produce another solution (E2B solution).

The E2A solution and the E2B solution were each stirred while heating to 100° C., so that each solution became homogeneous. Then, the E2A solution and E2B solution were mixed together and stirred for 7 hours, while heating to 200° C., until the solution mixture turned into a gel.

The gel thus formed was placed in an oven and was calcined in air at 500° C. for 4 hours, to obtain a composite oxide support. The atomic ratio of cerium to aluminum in the composite oxide support was 1:9.

Production of Supported Catalyst

0.405 g of Pt(NH₃)₄(NO₃)₂, which is a platinum precursor, was dissolved in 5 ml of water, and then the resulting solution was added dropwise to 10 g of the composite oxide support produced above. After the dropwise addition was completed, the composite oxide support having absorbed the solution of platinum precursor was dried in an oven at 110° C. for 16 hours, and then was calcined in air in an oven at 500° C. for 4 hours. Thus, a supported catalyst was obtained.

### EXAMPLE 3

Production of Composite Oxide Support

1.47 g of Ce(NO₃)₃.6H₂O was dissolved in a mixed solvent containing 8.38 g of ethylene glycol and 7.1 g of citric acid to produce a solution (E3A solution). Meanwhile, 12.2 g of ZrO (NO₃)₂ was dissolved in a mixed solvent containing 113.34 g of ethylene glycol and 111.17 g of citric acid to produce another solution (E3B solution).

The E3A solution and the E3B solution were each stirred while heating to 100° C., so that each solution became homogeneous. Then, the E3A solution and E3B solution were mixed together and stirred for 7 hours, while heating to 200° C., until the solution mixture turned into a gel.

The gel thus formed was placed in an oven and was calcined in air at 500° C. for 4 hours, to obtain a composite oxide support. The atomic ratio of cerium to zirconium in the composite oxide support was 1:9.

Production of Supported Catalyst

0.405 g of Pt(NH₃)₄(NO₃)₂, which is a platinum precursor, was dissolved in 5 ml of water, and then the resulting solution was added dropwise to 10 g of the composite oxide support produced above. After the dropwise addition was completed, the composite oxide support having absorbed the solution of platinum precursor was dried in an oven at 110° C. for 16 hours, and then was calcined in air in an oven at 500° C. for 4 hours. Thus, a supported catalyst was obtained.

### COMPARATIVE EXAMPLE 1

Production of Support

11.5 g of commercial γ-Al₂O₃ (available from Sigma-Aldrich Company) was introduced to 111.6 g of water and was heated to 60° C. 10.86 g of Ce(NO₃)₃.6H₂O was introduced to the mixture prepared above, and the whole mixture was stirred for about 6 hours until it became homogeneous. The resulting mixture was then subjected to evaporation of water under reduced pressure, while being heated to a temperature of 70° C. Then, the result was dried in an oven at 110° C. for 16 hours, and then was calcined in air in an oven at 500° C. for 4 hours. The atomic ratio of cerium to aluminum in the produced support was 1:9.

Production of Supported Catalyst

0.405 g of Pt(NH₃)₄(NO₃)₂, which is a platinum precursor, was dissolved in 100 ml of water, and then 10 g of the support produced above was mixed with the resulting solution. While maintaining the temperature at 60° C., the mixture was stirred until it became homogeneous. Then, the resulting mixture was subjected to evaporation of water under reduced pressure, while being heating to a temperature of 70° C. Subsequently, the result was dried in an oven at 110° C. for 16 hours, and then was calcined in air in an oven at 500° C. for 4 hours.

### COMPARATIVE EXAMPLE 2

Production of Support

20.4 g of commercial γ-Al₂O₃ (available from Sigma-Aldrich Company) was introduced to 217 g of water and was heated to 60° C. 43.4 g of Ce(NO₃)₃.6H₂O was introduced to the mixture prepared above, and the whole mixture was stirred for about 6 hours until it became homogeneous. The resulting mixture was then subjected to evaporation of water under reduced pressure, while being heated to a temperature of 70° C. Then, the result was dried in an oven at 110° C. for 16 hours, and then was calcined in air in an oven at 500° C. for 4 hours. The atomic ratio of cerium to aluminum in the produced support was 2:8.

Production of Supported Catalyst

A supported catalyst was produced in the same manner as in Comparative Example 1, except that the support produced above was used.

### COMPARATIVE EXAMPLE 3

0.405 g of Pt(NH₃)₄(NO₃)₂, which is a platinum precursor, was dissolved in 5 ml of water, and then the resulting solution was added dropwise to 10 g of the support produced in Comparative Example 2. After the dropwise addition was completed, the support having absorbed the solution of platinum precursor was dried in an oven at 110° C. for 16 hours, and then was calcined in air in an oven at 500° C. for 4 hours. Thus, a supported catalyst was obtained.

### COMPARATIVE EXAMPLE 4

A supported catalyst was produced in the same manner as in Example 1, except that a commercial support, γ-Al₂O₃ (available from Sigma-Aldrich Company) was used.

### COMPARATIVE EXAMPLE 5

A supported catalyst was produced in the same manner as in Example 1, except that a commercial support, CeO₂ (available from Sigma-Aldrich Company) was used.

### COMPARATIVE EXAMPLE 6

0.397 g of Pt(NH₃)₄(NO₃)₂, which is a platinum precursor, and 2.53 g of Ce(NO₃)₃.6H₂O, which is a cerium precursor, were dissolved in 30 g of water, and then 10 g of commercial γ-Al₂O₃ (available from Sigma-Aldrich Company) was introduced to the resulting solution. The mixture was homogeneously mixed, while heating to 60° C. and stirring for 1 hour. Then, an aqueous solution of NaOH at a concentration of 1 M was added dropwise to the mixture until the pH value reached 9. The resulting mixture was further stirred for about 1 hour, and then the resulting mixture was filtered, washed and dried. The result was dried in an oven at 110° C. for about 16 hours, and then was calcined in air in an oven at 500° C. for 4 hours.

### COMPARATIVE EXAMPLE 7

10 g of commercial γ-Al₂O₃ (available from Sigma-Aldrich Company) was introduced in 25 g of water and was heated to 60° C. 2.53 g of Ce(NO₃)₃.6H₂O was dissolved in the above mixture, and then the resulting mixture was stirred for about 1 hour. Then, a 1 M aqueous solution of NaOH was added dropwise to the mixture until the pH value reached 9. The resulting mixture was further stirred for about 1 hour, and then the mixture was filtered, washed and dried. The result was dried in an oven at 110° C. for about 16 hours, and then was calcined in air in an oven at 500° C. for 4 hours. Subsequently, 0.405 g of Pt(NH₃)₄(NO₃)₂, which is a platinum precursor, was dissolved in 5 ml of water, and the resulting solution was added dropwise to 10 g of the support produced above. After the dropwise addition was completed, the support having absorbed the solution of platinum precursor was dried in an oven at 110° C. for 16 hours, and then was calcined in air in an oven at 500° C. for 4 hours. Thus, a supported catalyst was obtained.

In order to examine the carbon monoxide removal performance of the supported catalysts produced in the Examples and Comparative Examples, a gas containing carbon monoxide was supplied to a reactor packed with each of the supported catalysts, and the concentration of carbon monoxide at the reactor outlet was measured.

The supplied gas consisted of water vapor and a gas mixture containing 10% by volume of carbon monoxide, 10% by volume of carbon dioxide and 80% by volume of hydrogen based on the dry portion (the portion of water vapor excluded) of the supplied gas. The water vapor was supplied such that a constant molar ratio between water vapor and carbon monoxide was maintained, as shown in Table 1 below. The reaction temperature was also selected as shown in Table 1. The flow rate of the supplied gas corresponded to a GHSV of 6000 hr⁻¹.

TABLE 1

| | | Method of | Method of | Water | Reaction | CO | CO |
|---|---|---|---|---|---|---|---|
| | | platinum | support | vapor/CO | temperature | concentration | conversion |
| Catalyst composition | | impregnation | production | (mol/mol) | (° C.) | (%, outlet) | rate (%) |
| Ex. 1 | Pt/CeO₂—Al₂O₃ | Incipient | Sol-gel | 2.5 | 250.6 | 1.31 | 85.38 |
| | (Ce/Al = 2/8) | wetness | method | 3.5 | 245.4 | 0.79 | 90.95 |
| Ex. 2 | Pt/CeO₂—Al₂O₃ | Incipient | Sol-gel | 2.5 | 250.1 | 1.26 | 86.51 |
| | (Ce/Al = 1/9) | wetness | method | 3.5 | 244.9 | 0.84 | 90.80 |
| Ex. 3 | Pt/CeO₂—ZrO2 | Incipient | Sol-gel | 3.5 | 256.9 | 1.24 | 87.02 |
| | (Ce/Zr = 1/9) | wetness | method | | | | |
| Comp. | Pt/CeO₂—Al₂O₃ | Wet | Wet | 2.5 | 268.9 | 1.76 | 80.49 |
| Ex. 1 | (Ce/Al = 1/9) | impregnation | impregnation | | | | |
| Comp. | Pt/CeO₂—Al₂O₃ | Wet | Wet | 2.5 | 281.0 | 2.08 | 76.89 |
| Ex. 2 | (Ce/Al = 2/8) | impregnation | impregnation | | | | |
| Comp. | Pt/CeO₂—Al₂O₃ | Incipient | Wet | 2.5 | 275.3 | 2.26 | 75.91 |
| Ex. 3 | (Ce/Al = 2/8) | wetness | impregnation | 3.5 | 283.4 | 1.67 | 82.40 |
| Comp. | Pt/γ-Al₂O₃ | Incipient | (Commercial) | 2.5 | 348.7 | 3.87 | 58.77 |
| Ex. 4 | | wetness | | | | | |
| Comp. | Pt/CeO₂ | Incipient | (Commercial) | 2.5 | 352.2 | 6.62 | 31.52 |
| Ex. 5 | | wetness | | | | | |
| Comp. | Pt—Ce/γ-Al₂O₃ | Co- | (Commercial) | 2.5 | 349.9 | 8.82 | 9.82 |
| Ex. 6 | | precipitation | | | | | |
| Comp. | Pt/CeO₂-γ- | Incipient | Co- | 2.5 | 288.0 | 1.69 | 81.62 |
| Ex. 7 | Al₂O₃ | wetness | precipitation | | | | |

When the cases where the ratio of water vapor to carbon monoxide was 2.5 are compared, it can be seen that the carbon monoxide conversions obtained with the supported catalysts produced in Example 1 and Example 2 exceeded 85%, while the carbon monoxide conversions obtained with the supported catalysts produced in Comparative Examples 1 through 7 hardly reached 80% in most cases. In some of the cases of Comparative Examples 1 through 7, the carbon monoxide conversions were even as low as 60% or less. The reaction temperatures used in Example 1 and Example 2 were lower than the reaction temperatures used in the Comparative Examples. Thus, the supported catalysts according to embodiments of the present invention showed remarkably superior carbon monoxide removal performance, compared with the supported catalysts produced in the Comparative Examples.

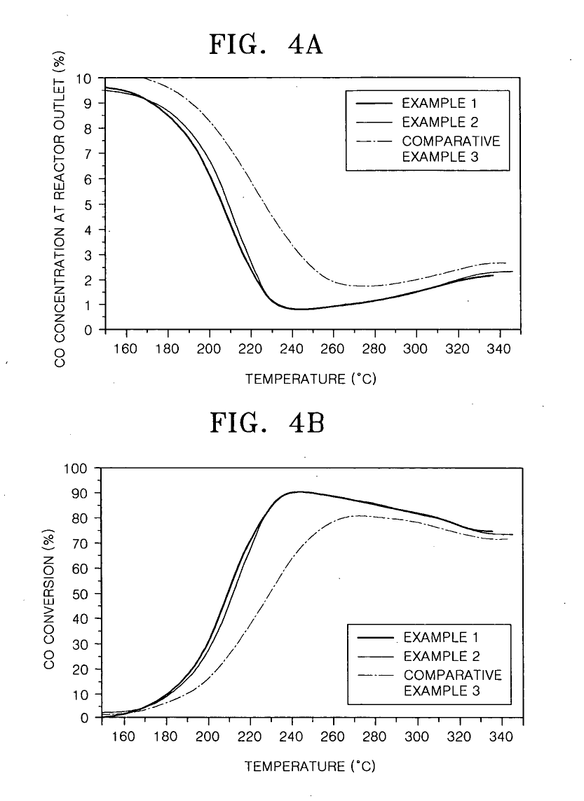

Such difference in the carbon monoxide removal performance was more obvious in the cases where the ratio of water vapor to carbon monoxide was 3.5. The concentration of carbon monoxide at the reactor outlet and the carbon monoxide conversion rate were measured, while varying the reaction temperature, for each of the supported catalysts produced in Examples 1 and 2 and Comparative Examples 1 through 7. FIG. 4A and FIG. 4B show the results of measuring the carbon monoxide concentration and the carbon monoxide conversion, respectively, for the supported catalysts produced in Examples 1 and 2 and Comparative Example 3. The maximum values of the carbon monoxide conversion were read from the graphs and are shown in Table 1.

As can be seen from Table 1, the carbon monoxide conversion rates in the cases of Example 1 and Example 2 exceeded 90%, while the carbon monoxide conversion rate in the case of Comparative Example 3 was 82.4%.

Therefore, it can be seen that the carbon monoxide removal performance of the supported catalysts obtained in Example 1 and Example 2 was significantly improved, compared with the same performance of the supported catalyst obtained in Comparative Example 3.

In addition, the specific surface areas and the degrees of dispersion of the supported catalysts produced in Examples 1 and 2 and Comparative Example 1 were measured. To this end, while passing an argon gas containing 10% by volume of hydrogen through the reactors packed with the respective supported catalysts at a flow rate of 30 sccm (standard cubic centimeters per minute), the supported catalysts were reduced at 300° C. for 1 hour. Then, carbon monoxide was adsorbed onto the supported catalysts by a pulse chemical adsorption method at 100° C., and the degrees of dispersion were measured. The specific surface areas of the supported catalysts were determined by a general nitrogen isotherm adsorption method, as BET surface areas. The results are presented in Table 2 below.

TABLE 2

| | | | Degree of |
|---|---|---|---|
| | | | dispersion |
| | | Specific | (mol of |
| | | surface area | CO/mol of |
| Catalyst composition | | (m²/g catalyst) | Pt × 100) |
| Ex. 1 | Pt/CeO₂—Al₂O₃ (Ce/Al = 2/8) | 196.1 | 86.5 |
| Ex. 2 | Pt/CeO₂—Al₂O₃ (Ce/Al = 1/9) | 233.8 | 89.1 |
| Comp. | Pt/CeO₂—Al₂O₃ (Ce/Al = 1/9) | 91.9 | 56.8 |
| Ex. 1 | | | |

As shown in Table 2, the degree of dispersion of platinum, which was the transition metal active component, and the specific surface area significantly improved in the cases of Example 1 and Example 2, compared with the case of Comparative Example 1.

The excellent carbon monoxide removal performance obtained with the supported catalysts produced in Example 1 and Example 2 as shown in Table 1 is suspected to be attributable to the high degree of dispersion of the transition metal active component and the high specific surface area.

Thus, the low temperature water gas shift reaction catalyst produced using the composite oxide support according to aspects of the present invention has an effect of carbon monoxide removal with a higher conversion rate at a lower temperature compared with conventional catalysts for water gas shift reaction.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A composite oxide support, comprising ceria (CeO₂) and an oxide of M₁ such that the atomic ratio of cerium (Ce) in the ceria to M₁ is in the range of 1:4 to 1:40,
wherein M₁ is at least one metal selected from aluminum (Al), zirconium (Zr) and titanium (Ti).

2. The composite oxide support of claim 1, wherein the amount of the ceria in the composite oxide support is 3 to 20% by weight, based on the total weight of the composite oxide support.

3. The composite oxide support of claim 1, wherein the oxide of M₁ is alumina (Al₂O₃).

4. The composite oxide support of claim 1, wherein the composite oxide support has a specific surface area of 20 m²/g to 1,500 m²/g.

5. A method of producing a composite oxide support, comprising:
dissolving a ceria (CeO₂) precursor in a mixed solvent of an alcohol-based solvent and an acid to obtain a first oxide precursor solution;
dissolving at least one metal oxide precursor selected from alumina (Al₂O₃) precursors, zirconia (ZrO₂) precursors and titania (TiO₂) precursors in a mixed solvent of an alcohol-based solvent and an acid to obtain a second oxide precursor solution;
mixing and heating the first oxide precursor solution and the second oxide precursor solution to form a solution mixture in a gel state; and
calcining the resulting solution mixture in the gel state to obtain the composite oxide support.

6. The method of claim 5, wherein the ceria precursor includes at least one selected from the group consisting of Ce(NO₃)₃.6H₂O, Ce(CH₃CO₂)₃, Ce(CO₃)₃, CeCl₃, (NH₄)₂Ce(NO₃)₆, (NH₄)₂Ce(SO₄)₄, Ce(OH)₄, Ce₂(C₂O₄)₃, Ce(ClO₄)₃ and Ce₂(SO₄)₃; The alumina precursor includes at least one selected from the group consisting of Al(NO₃)₃.9H₂O, AlCl₃, Al(OH)₃, AlNH₄(SO₄)₂.12H₂O, Al((CH₃)₂CHO)₃, Al(CH₃CH(OH)CO₂)₂, Al(ClO₄)₃.9H₂O, Al(C₆H₅O)₃, Al₂(SO₄)₃.18H₂O, Al(CH₃(CH₂)₃O)₃, Al(C₂H₅CH(CH₃)O)₃Al and Al(C₂H₅O)₃, the zirconia precursor includes at least one selected from the group consisting of ZrO(NO₃)₂, ZrCl₄, Zr(OC(CH₃)₃)₄, Zr(O(CH₂)₃CH₃)₄, (CH₃CO₂)Zr(OH), ZrOCl₂, Zr(SO₄)₂, and Zr(OCH₂CH₂CH₃)₄; and the titania precursor includes at least one selected from the group consisting of Ti(NO₃)₄, TiOSO₄, Ti(OCH₂CH₂CH₃)₄, Ti(OCH(CH₃)₂)₄, Ti(OC₂H₅)₄, Ti(OCH₃)₄, TiCl₃, Ti(O(CH₂)₃CH₃)₄ and Ti(OC(CH₃)₃)₄.

7. The method of claim 5, wherein the calcining is performed at a temperature of 400° C. to 700° C.

8. The method of claim 5, wherein the weight ratio of the ceria precursor, the alcohol-based solvent and the acid in the first oxide precursor solution is in the range of 1:10:2 to 1:80:20.

9. The method of claim 5, wherein the weight ratio of the at least one metal oxide precursor selected from alumina precursors, zirconia precursors and titania precursors; the alcohol-based solvent; and the acid in the second oxide precursor solution, is in the range of 1:10:2 to 1:80:20.

10. The method of claim 5, wherein the alcohol-based solvent is a monohydric alcohol having 1 to 10 carbon atoms, or a dihydric alcohol having 1 to 10 carbon atoms.

11. The method of claim 5, wherein the mixing and heating of the first oxide precursor solution and the second oxide precursor solution to form the solution mixture in the gel state, is performed at a temperature of 100° C. to 200° C.

12. The method of claim 5, wherein the atomic ratio of cerium in the ceria precursor to the metal component in the at least one metal oxide precursor selected from alumina precursors, zirconia precursors and titania precursors, is in the range of 1:4 to 1:40.

13. A low temperature water gas shift reaction catalyst, comprising:
a composite oxide support comprising ceria (CeO₂) and an oxide of M₁ such that the atomic ratio of cerium in the ceria to M₁ is in the range of 1:4 to 1:40, wherein M₁ is at least one metal selected from aluminum (Al), zirconium (Zr) and titanium (Ti); and
a transition metal active component supported on the composite oxide support.

14. The low temperature water gas shift reaction catalyst of claim 13, wherein the proportion of the transition metal active component is 1 to 10% by weight, based on the total weight of the low temperature water gas shift reaction catalyst.

15. The low temperature water gas shift reaction catalyst of claim 13, wherein the transition metal active component is in the form of particles and wherein the degree of dispersion of the particles of the transition metal active component is 60% or greater.

16. The low temperature water gas shift reaction catalyst of claim 13, wherein the transition metal active component is platinum (Pt), or an alloy of platinum with palladium (Pd), nickel (Ni), cobalt (Co), ruthenium (Ru), rhenium (Re), rhodium (Rh), osmium (Os), titanium (Ti), vanadium (V), chromium (Cr), manganese (Mn), iron (Fe), copper (Cu), cerium(Ce) or zinc (Zn).

17. The low temperature water gas shift reaction catalyst of claim 13, wherein the proportion of the ceria is 3 to 20% by weight, based on the total weight of the composite oxide support.

18. The low temperature water gas shift reaction catalyst of claim 13, wherein the oxide of M₁ is alumina (Al₂O₃).

19. The low temperature water gas shift reaction catalyst of claim 13, wherein the composite oxide support has a specific surface area of 20 m²/g to 1,500 m²/g.

20. A method of producing a low temperature water gas shift reaction catalyst, comprising:
dissolving a ceria (CeO₂) precursor in a mixed solvent of an alcohol-based solvent and an acid to obtain a first oxide precursor solution;
dissolving at least one metal oxide precursor selected from alumina (Al₂O₃) precursors, zirconia (ZrO₂) precursors and titania (TiO₂) precursors in a mixed solvent of an alcohol-based solvent and an acid to obtain a second oxide precursor solution;
mixing and heating the first oxide precursor solution and the second oxide precursor solution to form a solution mixture in a gel state;
calcining the solution mixture in the gel state to produce a composite oxide support;
impregnating a transition metal active component into the composite oxide support by an incipient wetness method to obtain an impregnation product; and
calcining the impregnation product to obtain the low temperature water gas shift reaction catalyst.

21. The method of claim 20, wherein the calcining of the impregnation product is performed at a temperature of 300° C. to 700° C.

22. The method of claim 20, wherein the ceria precursor includes at least one selected from the group consisting of Ce(NO₃)₃.6H₂O, Ce(CH₃CO₂)₃, Ce(CO₃)₃, CeCl₃, (NH₄)₂Ce(NO₃)₆, (NH₄)₂Ce(SO₄)₄, Ce(OH)₄, Ce₂(C₂O₄)₃, Ce(ClO₄)₃ and Ce₂(SO₄)₃ the alumina precursor includes at least one selected from the group consisting of Al(NO₃)₃.9H₂O, AlCl₃, Al(OH)₃, AlNH₄(SO₄)₂.12H₂O, Al((CH₃)₂CHO)₃, Al(CH₃CH(OH)CO₂)₂, Al(ClO₄)₃ .9H₂O, Al(C₆H₅O)₃, Al₂(SO₄)₃.18H₂O, Al(CH₃(CH₂)₃O)₃, Al(C₂H₅CH(CH₃)O)₃Al and Al(C₂H₅O)₃; the zirconia precursor includes at least one selected from the group consisting of ZrO(NO₃)₂, ZrCl₄, Zr(OC(CH₃)₃)₄, Zr(O(CH₂)₃CH₃)₄, (CH₃CO₂)Zr(OH), ZrOCl₂, Zr(SO₄)₂, and Zr(OCH₂CH₂CH₃)₄; and the titania precursor includes at least one selected from the group consisting of Ti(NO₃)₄, TiOSO₄, Ti(OCH₂CH₂CH₃)₄, Ti(OCH(CH₃)₂)₄, Ti(OC₂H₅)₄, Ti(OCH₃)₄, TiCl₃, Ti(O(CH₂)₃CH₃)₄and Ti(OC(CH₃)₃)₄.

23. The method of claim 20, wherein the calcining of the solution mixture in the gel state is performed at a temperature of 400° C. to 700° C.

24. The method of claim 20, wherein the weight ratio of the ceria precursor, the alcohol-based solvent and the acid in the first oxide precursor solution is in the range of 1:10:2 to 1:80:20.

25. The method of claim 20, wherein the weight ratio of the at least one metal oxide precursor selected from alumina precursors, zirconia precursors and titania precursors; the alcohol-based solvent; and the acid in the second oxide precursor solution is in the range of 1:10:2 to 1:80:20.

26. The method of claim 20, wherein the alcohol-based solvent is a monohydric alcohol having 1 to 10 carbon atoms, or a dihydric alcohol having 1 to 10 carbon atoms.

27. The method of claim 20, wherein the mixing and heating of the first oxide precursor solution and the second oxide precursor solution to form the solution mixture in the gel state, is performed at a temperature of 100° C. to 200° C.

28. The method of claim 20, wherein the atomic ratio of cerium in the ceria precursor to the metal component in the at least one metal oxide precursor selected from alumina precursors, zirconia precursors and titania precursors, is in the range of 1:4 to 1:40.

29. A method of removing carbon monoxide from a gas containing carbon monoxide, comprising contacting the low temperature water gas shift reaction catalyst of claims 13 with the gas containing carbon monoxide.

30. The method of claim 29, wherein the contacting is performed at a temperature of 200° C. to 280° C.

31. A fuel processor containing the composite oxide support of claim 1.

32. A fuel processor including an apparatus for a low temperature water gas shift reaction comprising a low temperature water gas shift reaction catalyst comprising the composite oxide support of claim 1.

33. A fuel processor containing a single water gas shift reaction reactor, wherein the single water gas shift reaction reactor comprises a water gas shift reaction catalyst comprising the composite oxide support of claim 1.

34. A fuel cell system comprising a fuel stack and a fuel processor, wherein the fuel processor contains the composite oxide support of claim 1.

35. A fuel cell system comprising a fuel stack and a fuel processor, wherein the fuel processor includes an apparatus for a low temperature water gas shift reaction that comprises a low temperature water gas shift reaction catalyst that comprises the composite oxide support of claim 1.

36. A fuel cell system comprising a fuel stack and a fuel processor, wherein the fuel processor contains a single water gas shift reaction reactor, wherein the single water gas shift reaction reactor comprises a water gas shift reaction catalyst comprising the composite oxide support of claim 1.
